(19) United States
(12) Patent Application Publication
(10) Pub. No.: US 2002/0087529 A1
(43) Pub. Date: Jul. 4, 2002

(54) System and method for a digital business card

(75) Inventors: William R. Dutcher, Great Falls, VA (US); Timothy J. Griswold, Fairfax, VA (US)

Correspondence Address: SUGHRUE MION, PLLC, 2100 Pennsylvania Avenue, NW, Washington, DC, 20037-3213, US

(73) Assignee: VERISIGN

(21) Appl. No.: 10/004,842

(22) Filed: Dec. 7, 2001

Related U.S. Application Data
(60) Provisional application No. 60/251,587, filed on Dec. 7, 2000.

(51) Int. Cl. G06F 7/00

(52) U.S. Cl. 707/3

(57) ABSTRACT

A system that provides users of both fixed and wireless Internet devices, a method of entering numbers instead of the text characters of Internet Uniform Resource Locators (URLs) and other Internet identifiers to access Internet resources and functions, such as Web sites and digital business cards. When the user enters a WebNum, the digits of the WebNum are processed by the WebNum system and the WebNum is mapped back to a URL or a file containing the content of a digital business card. The content is specially formatted for display on a wireless device. For a WebNum mapping to a digital business card, a WebNum application server retrieves the content and returns it to the device for displaying.

### RELATED APPLICATIONS

The present invention is based on U.S. Provisional Patent Application 60/251,587 filed Dec. 7, 2000, and claims the benefit thereof.

### BACKGROUND OF THE INVENTION

The present invention is directed to a system and method that can give users of both fixed and wireless Internet devices access to content of a type of digital or virtual business card (hereinafter “My Card”) over the Internet by using a Private Numbering System (hereinafter “the WebNum system”).

An example of a WebNum system is described in co-pending, commonly assigned Application Ser. No. 09/930,44, entitled “A Numeric/Voice Name Internet Access Architecture and Methodology”, the entire contents of which are specifically incorporated herein by reference. The WebNum System is a system for accessing Internet Web sites from a cellular telephone or a wireless Internet device (WID), such as a handheld computer or a personal digital assistant.

Traditionally, accessing Internet resources using a cell phone to input a text Uniform Resource Locator (URL) has been difficult and cumbersome because cell phones have a numeric keypad instead of an alphanumeric keyboard. The WebNum system provides a method of reaching Internet resources quickly and easily from a cell phone, by keying in numbers on the telephone or WID keypad, instead of typing the text URL of the resource.

Cell phones and WIDs usually lack the rich user interface of a PC, and usually have a very limited amount of display space. Also, many Web sites do not have WID-compatible content.

### SUMMARY OF THE INVENTION

It is therefore an object of the present invention to provide a system that allows users to more easily access digital content through the Internet from a wireless device.

In accordance with one embodiment of the present invention, a WebNum system allows users to access My Cards, stored in files, through the Internet by entering numbers instead of text URLs on cellular telephones and other wireless Internet devices. The WebNum system is a unique system of using numerical digits, including specially-designated numeric combinations, standard telephone numbers, and international telephone numbers, that directs Web-enabled cell phones and WIDs to Internet Web sites and other Internet resources, such as My Cards.

In a preferred embodiment, when a user enters a WebNum, the digits of the WebNum are sent to a special database on a system that is accessible over the Internet. The database maps the WebNum to either a URL or a file containing the digital content of the My Card associated with the WebNum. For example, the WebNum 877, entered by a user on a cell phone or WID, may map in the database to an Internet URL, such as http://www.xyz.com/card.txt. This URL would subsequently be resolved through the Internet Domain Name System (DNS) to identify the IP address of the Web site associated with WebNum 887, which contains the My Card file “card.txt”.

The cell phone provider or WID network provider would then retrieve the My Card file from the Web site over the Internet, to return its content to the cell phone or WID display. In most cases, the content of the My Card will have been specially formatted for display on the cell phone or WID display, but such reformatting is not necessary to implement the invention. A number of cell phone and WID Web browsers and markup languages can be used, but the My Card content should be compatible with those browsers and languages used by cell phones and WIDs. By way of example and not by way of limitation, My Cards can be rendered in a number of languages such as cHTML, WML, XML, HTML, HDML, and mHTML.

Thus, in addition to allowing a user to reach an Internet Web site, a WebNum shortcut can allow a user to reach a My Card, which may include, by way of example and not by way of limitation, a display of text, contact information, graphics, advertising, and other data. The digital content of the My Card and the format of its display may be created or modified by the WebNum registrant or by a third party designated by the registrant.

It is another object of the present invention to provide a system that allows a user to substitute a My Card, which is more suitable for displaying on a cell phone or other WID, for a traditional Web site. A My Card also allows a registrant to provide an alternative source of digital content in addition to a traditional Web site.

The My Card expands the WebNum concept by allowing a WebNum registrant to substitute, by way of example and not by way of limitation, text, graphics, and interactive data for a Web site URL. Furthermore, the content of a My Card may be specially formatted for display on a cell phone or WID display.

Finally, the My Card concept can be extended to incorporate other types of content, such as video, audio, or multimedia content, geographical positioning information, business applications, on-line services, e-mail and messaging systems, virtual private networks, interactive data and services, or network services.

### BRIEF DESCRIPTION OF THE DRAWINGS

FIG. 1 is a diagram showing aspects of one embodiment of the present invention.

FIG. 2 is a flow chart showing a typical use of the present invention to retrieve a digital business card from a database connected to the WebNum App server.

FIG. 3 is a flow chart showing another use of the present invention to retrieve a digital business card from a Web site through the Internet.

### DETAILED DESCRIPTION OF THE PREFERRED EMBODIMENTS

It is important to note that while the preferred emdobiment is described as an implementation of a “My Card” system on the “WebNum” system, it is not necessary to use these exact commercial systems to practice the invention. In accordance with a preferred embodiment of the present invention, the My Card system provides digital content, suitable for display on a cell phone or other WID, that is accessible using the WebNum system. The functionality of the WebNum system is retained, and the My Card system expands this functionality by allowing users to also map a WebNum to a My Card.

### My Card System Operation

Accessing a My Card

A fixed or wireless Internet device may be used to access a My Card, including, by way of example and not by way of limitation, Internet-capable cell phones and wireless Internet devices, Internet-capable computers, and wireline phones that are Internet-capable.

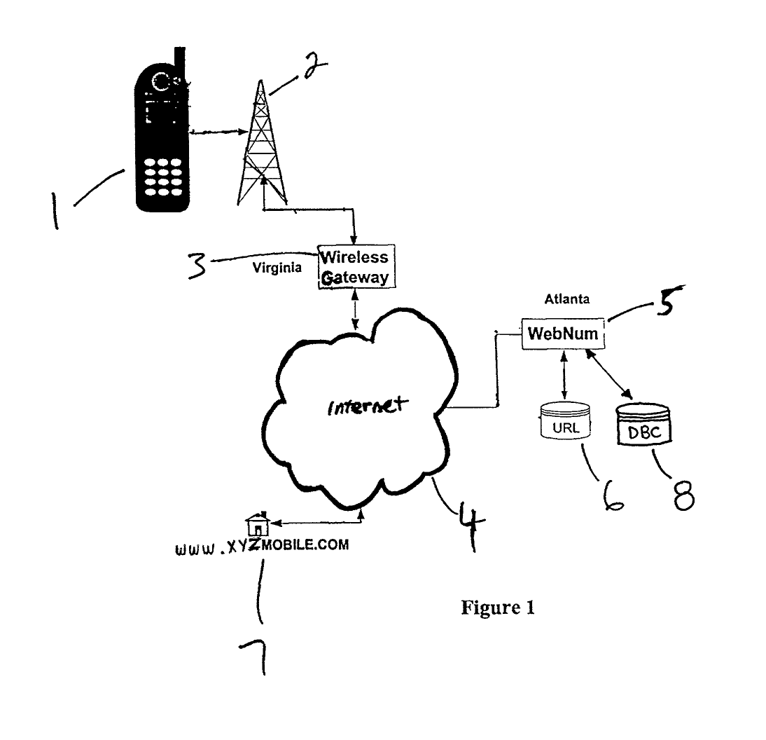

With reference to FIG. 1, a WebNum entered on a cell phone or WID 1 is sent from the device to the WebNum App 5, which preferably runs on a server located at the wireless service provider's gateway 3, or elsewhere on the Internet 4. The WebNum App 5 accesses either tables or database 6 to resolve the number to an Internet URL or other My Card identifier. The Digital Business Card storage medium 8 contains files that hold the content of the stored My Cards. The translation tables and database 6, as well as storage medium 8, can be local to the WebNum App 5, or accessed from a remote location.

In a preferred embodiment, the URL of the WebNum system should be known to the cell phone or WID, in order to reach the WebNum App site. The cell phone or WID service provider may make the WebNum system a menu item on the service menu, or a pointer to the WebNum system may be embedded in the cell phone or WID operating software.

Also in a preferred embodiment, the browser/cell phone 1 is aware that the number entered is a WebNum, because of how and where it was entered in the context of the cell phone's Web browser, display menus, and function buttons. The wireless system knows the identity of the cell phone that originated the transaction. The WebNum system will convert the WebNum to an Internet URL or identifier, which will point the cell phone 1 to the associated resource.

The WebNum is sent to the WebNum database server 6 at the wireless carrier or on the Internet, which maps the WebNum to a URL pointing to a My Card file accessible through the Internet 4 or directly to a My Card file stored in storage medium 8. For example, an employee of XYZ Corporation named Smith could create his My Card such that the WebNum 777 may map in the database 6 to the URL www.XYZmobile.com/smith.crd, as:

777=www.XYZmobile.com/smith.crd

Alternatively, the WebNum 777 may map in the database 6 directly to the My Card file “smith.crd”, as:

777=smith.crd

Thus, the WebNum will map to either a URL, which contains a hostname in the Internet domain name structure, or to a file that contains the contents of the registrant's My Card. The WebNum App may also point the request to another server that contains the contents of the registrant's My Card.

If the WebNum is found to match a URL in the database 6, the response is sent back to the WebNum App 5, where an access is made to retrieve the site using standard DNS procedures.

The fully-formed URL points to a resource on the Internet 4. The URL must be translated to an IP address through traditional DNS lookup mechanisms. When the wireless switch receives the IP address resolved from its DNS resolution request, the switch creates an IP datagram, using the protocol specified in the URL, and passes the IP datagram to an Internet Service provider (ISP) for delivery on the Internet.

In this example, the response that comes back from the Internet Web site 7 will be the content of the My Card file located at www.XYZmobile.com/smith.crd.

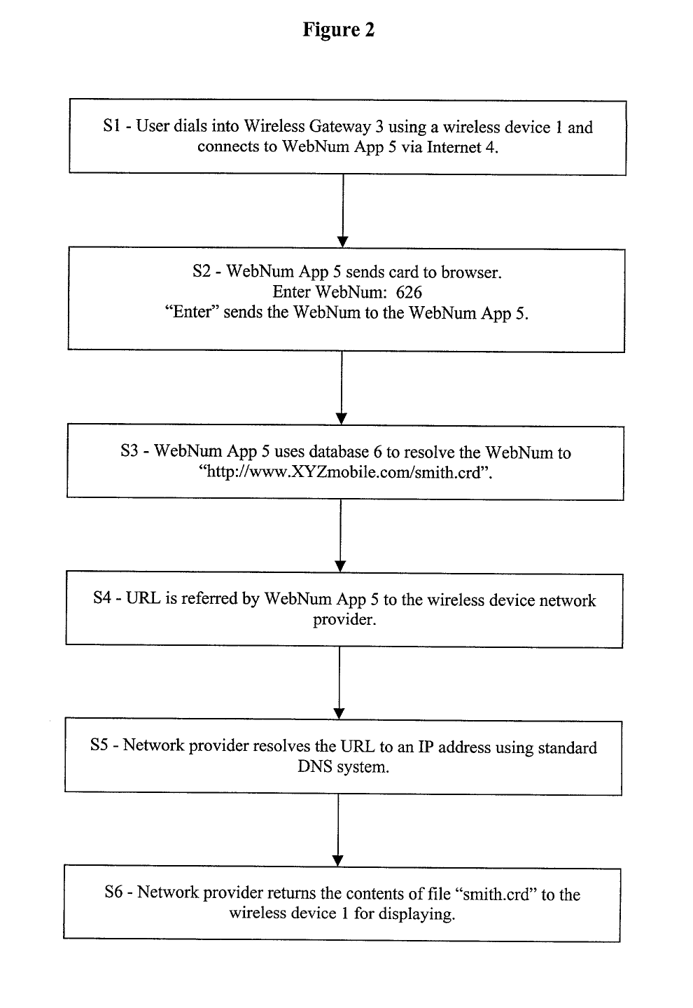

FIG. 2 illustrates this example. First, a user dials into Wireless Gateway 3 and connects to the WebNum App 5 via the Internet 4. (S1) Next, the WebNum App interfaces with the browser running on the device, and awaits a WebNum to be entered on the device and transmitted to the WebNum App. (S2) Upon receiving the WebNum, the WebNum App uses database 6 to resolve the WebNum to a URL, “http://www.XYZmobile.com/smith.crd”. (S3) Next, the WebNum server returns a referral to the URL to the cell system or WID network provider. (S4) The network provider then resolves the URL to an IP address through the DNS, and returns the Web site corresponding to the URL to the cell phone or WID for display. (S5 and S6)

If the WebNum is found to match a My Card in the database 6, the response is sent back to the WebNum App 5, where the contents of the My Card can be retrieved from the storage medium 8 and returned to the cell phone or WID, where it is displayed on the device's display.

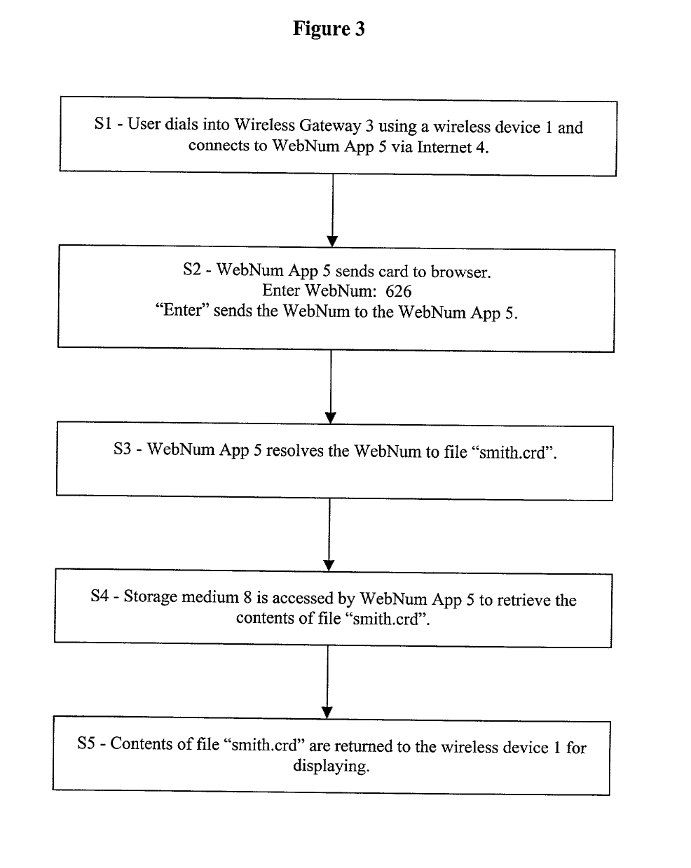

FIG. 3 illustrates this example. First, a user dials into Wireless Gateway 3 and connects to the WebNum App 5 via the Internet 4. (S1) Next, the WebNum App interfaces with the browser running on the device, and awaits a WebNum to be entered on the device and transmitted to the WebNum App. (S2) Upon receiving the WebNum, the WebNum App uses database 6 to resolve the WebNum to a file “smith.crd”, which contains the content of a particular My Card. (S3) Then, the WebNum App accesses the storage medium 8 to retrieve the contents of file “smith.crd”. (S4) Finally, the contents of file “smith.crd” are returned to the wireless device 1 for display. (S5)

In an alternative embodiment, the WebNum system is used to support voice access to My Cards.

In the above embodiments, the My Card system can hide the entire process of translating a WebNum to a URL or My Card file, then resolving the IP address if necessary, then retrieving the data for the My Card.

Creating a My Card

The content and format of the display, referred to as My Card, may be created by the WebNum registrant, or by a third party designated by the registrant.

In one embodiment, My Cards can be created through the WebNum registration Web site, through a Web site maintained and managed by a third party, or from a cell phone, WID, or Internet-enabled wireline telephone. WebNum registrants may use these sites, by way of example and not by way of limitation, to select and register a WebNum, to designate a Web site or My Card to which a WebNum will be mapped, and to specify the content of a My Card. Registrants may also use the registration Web site to designate if the use of the WebNum on a cell phone or WID will point to an Internet Web site, or to the My Card.

In an alternative embodiment, when an individual, organization, or corporation registers a WebNum, the user may have the option of creating a My Card for the WebNum, and of designating if the registrant wants the Web site or the My Card to appear when the WebNum is entered on a cell phone or WID.

In an alternative embodiment, the selected WebNum to be associated with the My Card is unique. As with regular internet addresses, a selected WebNum could be the subject of a central registration process to ensure that each WebNum is unique. This approach is preferred, however, not necessary to practice the invention.

For instance, it is possible to have different WebNum service providers, each with a different access process. So for example, the WebNum 626 might be mapped by one service provider to www.XYZ.com, while another service provider maps it to www.ABC.com. In such a scenario, the user would have to know which WebNum provider he/she is using and the specific WebNum relationship within that provider.

Also, the My Card system supports many-to-one relationships, in which multiple numeric (and/or voice) shortcuts can be linked to a single My Card, or other Internet resource or service.

Modifying a My Card

The content and format of a My Card may be modified by the WebNum registrant, or by a third party designated by the registrant.

In one embodiment, My Cards can be modified through the WebNum registration Web site, through a Web site maintained and managed by a third party, or from a cell phone, WID, or Internet-enabled wireline telephone. WebNum registrants may use these sites, by way of example and not by way of limitation, to change the WebNum associated with a Web site or My Card, to change the Web site to which a WebNum will be mapped, and to change the content of a My Card. Additional content can be added to the My Card, existing content can be removed from the My Card, and existing content of the My Card can be edited. Registrants may also use the WebNum Web site to change whether the use of the WebNum on a cell phone or WID will point to an Internet Web site, or to the My Card.

The My Card system described above provides a system in which a registered user can substitute a My Card, which is accessible by a WebNum, for a traditional Web site or may offer the My Card in addition to a traditional Web site. For example, the traditional Web site could be given to users having fixed devices with normal input and display means, while the My Card could be given to users having wireless devices with limited input and display means.

### My Card Structure

A My Card is a personal Web page that is accessible from Internet-capable cell phones and wireless Internet devices, Internet-capable computers, and wireline phones that are Internet-capable. A WebNum registrant who does not have a Web site or one without WID-compatible content, may use a My Card as a Web site for wireless Internet devices.

Preferably, the content of a My Card file is specially formatted for displaying on a cell phone or other such WID. A number of cell phone and WID Web browsers and markup languages are in use, but the My Card content should be compatible with those used by phones and WIDs. For example, My Cards should be rendered in a number of display languages, such as cHTML, WML, XML, HTML, HDML, and mHTML

In a preferred embodiment, the My Card is a file that is displayed on the user's cell phone or WID in response to the user entering a WebNum. A number of data elements may be incorporated in a My Card, all of which may be stored together in the same file, or in different files on the same or separate servers.

The display of an all-text My Card might emulate a standard business card, and include some or all of the following fields:

Name: John Jones

Company: XYZ Corporation

Title: VP, Sales

Phone: 703-742 0400

Cellular: 703-786-1234

E-mail: jjones@netsol.com

The My Card may contain freeform text, and display as:

XYZ Corporation

World's Best Widgets

WWW.widgets.com

1-800-WIDGETS

WebNum registrants may use the My Card as a message board, for example:

Ristorante Il Fantino

(508) 123-4567

Today's Specials

Linguini & Clams

Veal Marsala

Soupa di Pesce

In this example, the first three lines are relatively static, and the last three lines contain variable data, likely to change on a daily basis.

My Cards may also contain interactive links, which allow the recipient to select part of the display to send an e-mail or a Short Message System message, dial a phone number, or link to a Web site. The My Card may also indicate the subscriber's preferred method of being contacted, based on location or presence information that updates the My Card dynamically. My Cards could also support a private, password-protected message field, so that only visitors with the password can view the field. Also, while My Cards are generally described herein as virtual business cards, it is also within the scope of the invention and the term “business card” to cover a personal card, such as personal contact information.

My Cards may also contain graphics, logos, pictures, or other non-textual content, just like a standard Internet Web site. However, the display or presentation of non-textual content will be determined by the display characteristics of the cell phone or WID. Some cell phones or WIDs may not be able to display graphics or photos at all, some may only be able to display certain types of graphics files, and the resolution of cell phone and WID displays varies. The display format of the content of the My Card will depend on the display characteristics of the cell phone or WID used to access the WebNum system, but the graphics display capability is part of the design and operation of the My Card system.

Another embodiment of the My Card system allows for My Card content to be created, stored, and displayed in foreign languages, including those that use non-Latin alphabets or character sets, such as Japanese, Chinese, Korean, and Arabic. The characters, figures, or ideograms of My Card content that is created in a non-Latin character set can be translated to standard eight-or 16-bit Unicode characters, or those of other character encoding schemes, and stored in the My Cards.

A WebNum may be mapped either to a URL or to the digitally encoded content of a My Card. The interpretation of digitally encoded content that is stored in the My Card server is irrelevant to the WebNum system. Rather, the interpretation depends on the device that displays that content, such as a cell phone, a WID, or an Internet-enabled wireline telephone. In most cases, a cell phone or WID according to this embodiment should have the ability to display specific non-Latin character sets, such as Japanese or Chinese characters.

The display characteristics of the cell phone or WID, and the encoding of the content of a My Card, are independent of the operation of the WebNum and the My Card systems. The WebNum and My Card systems neither specify nor create the glyph images, or visual representations of characters, for cell phones or WIDs. The software or hardware-rendering engine of a cell phone or WID is responsible for the appearance of the characters on the display, as well as the appearance of graphic images.

### My Card Storage

My Card content may be stored in one or more files, and these files may be stored on the same server as the WebNum application system, on another server, on an Internet Web site, or on systems run by cell phone or WID network providers, ISPs, or other service providers, or some combination thereof.

### Extensions

Extensions of the My Card concept may include linking the WebNum to a number of other types of content, such as video, audio, or multimedia content, geographical positioning information, business applications, on-line services, e-mail and messaging systems, virtual private networks, interactive data and services, or other network services, as described for the WebNum system.

### WebNum Numbers

In a preferred embodiment of the My Card system, the basic WebNum is a string of digits from one to 16 digits in length, that does not include any extensions or escape sequences. WebNum shortcuts may be E.164 telephone numbers, which are numbers from eight to 12 digits long, or they may be strings of digits from one to seven digits in length.

One type of WebNum is an E.164 number, which in the United States is a eleven-digit phone number of the form <1><area code><exchange><extension>, such as 1-212-123-4567. The E.164 numbering plan is a standard for international public telephone numbering that has been established by the International Telecommunication Union (ITU). In this example, 1 is the country code for the United States. A U.S. E.164 number may be entered as a WebNum as an eleven digit number, as:

1 212 123 4567<Send>

WebNum shortcuts may also be telephone numbers that are not preceded by country codes. In the example above, the phone number 212-123-4567 could also be registered as WebNum 2121234567.

In another embodiment of the My Card system, the WebNum number can be any number supported by the WebNum system.

WebNum shortcuts are designed to simplify and speed access from devices with limited input capabilities, such as cell phones and other wireless devices that have numeric keypads and pen-based input, as well as speech-to-text and speech recognition systems. Because the primary emphasis is on wireless and other devices with limited input functions and display means, the My Card system is a logical extension of the WebNum system because it allows a user to map a WebNum to a My Card, a sort of digital business card. My Cards may be used as a substitute for or in addition to a traditional Web site. Preferably, the content of the My Cards is specially formatted for display on the wireless devices. Nonetheless, the function and benefits described for the My Card system are also available for other web-enabled devices such as fixed Internet devices, personal computers, etc.

As used in the appended claims, the term “controller” could be implemented as a single computer or multiple computers, one or more microprocessors, one or more servers, one or more database controllers, or other like system.

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention.

What is claimed is:

1. A method for accessing a digital business card based on a request from a device, comprising:
receiving a transmitted short name from said device, said short name comprising a code number representative of a particular digital business card;
searching a database for said short name, said database being located at a location remote from said device;
if said short name is found, retrieving said particular digital business card and returning said particular digital business card to said device; and
displaying said particular digital business card on said device.

2. A method according to claim 1, wherein said device is a wireless device.

3. A method according to claim 1, wherein said database is accessed over the internet.

4. A method according to claim 2, wherein said database is accessed through a service provider without traversing the internet.

5. A method according to claim 4, wherein said service provider is a wireless service provider.

6. A method according to claim 1, wherein said short name is received by a software application that queries said database.

7. A method according to claim 6, wherein at least one of said software application and said database maps said short name to said digital business card.

8. A method according to claim 1, wherein multiple short names can map to a single digital business card.

9. A method according to claim 1, further comprising:
if said database indicates that said short name is not found, searching a second database for said short name.

10. A method according to claim 1, further comprising a plurality of databases, said databases arranged in a logical hierarchy so that if said short name is not found in a first database, said searching is resubmitted to a next database in said hierarchy.

11. A method according to claim 2, wherein said short name is input to said wireless device in the form of a voice command, and said voice command is converted to a non-voice command after being transmitted by said wireless device.

12. A method according to claim 11, wherein said voice command is converted to a non-voice command by a computer connected to said wireless device via a network.

13. A method according to claim 1, wherein said short name corresponds to a phone number in E.164 format.

14. A method according to claim 1, wherein said short name corresponds to a phone number.

15. A method according to claim 1, wherein said short name is registered with a central authority for the internet.

16. A method according to claim 2, wherein a content of said digital business card is formatted for display on said wireless device.

17. A method according to claim 16, wherein said content is formatted in a display language selected from the group of display languages that are compatible with said device, said group of display languages includes WML, XML, HTML, HDML, cHTML, and mHTML.

18. A method according to claim 2, wherein said short name consists of only numeric characters contained on a keypad of said wireless device.

19. A method according to claim 1, wherein said digital business card includes a textual content.

20. A method according to claim 1, wherein said digital business card includes a non-textual content.

21. A method according to claim 19, wherein said textual content is a foreign language.

22. A method according to claim 20, wherein said non-textual content is a foreign language using a non-Latin alphabet or character set.

23. A method for creating a digital business card using a device, comprising:
contacting a registration Web site;
selecting a short name to be associated with said digital business card;
specifying a content of said digital business card;
associating said short name with said digital business card; and
storing said digital business card.

24. A method according to claim 23, wherein said registration Web site is maintained and managed by a third party.

25. A method according to claim 23, wherein said selected short name is registered with a central authority for the Internet.

26. A method according to claim 23, wherein said selected short name is unique.

27. A method according to claim 23, wherein said device is a wireless device.

28. A method according to claim 23, wherein said digital business card is stored in one or more databases.

29. A method according to claim 28, wherein at least one of said one or more databases is connected to the Internet.

30. A method according to claim 28, wherein none of said one or more databases is connected to the Internet.

31. A method according to claim 27, wherein said short name is selected by a voice command input to said wireless device, and said voice command is converted to a non-voice command after being transmitted by said wireless device.

32. A method according to claim 31, wherein said voice command is converted to said non-voice command by a computer connected to said wireless device via a network.

33. A method according to claim 23, wherein said selected short name corresponds to a phone number in E.164 format.

34. A method according to claim 23, wherein said selected short name corresponds to a phone number.

35. A method according to claim 23, wherein said content includes a textual content.

36. A method according to claim 23, wherein said content includes a non-textual content.

37. A method according to claim 35, wherein said textual content is a foreign language.

38. A method according to claim 36, wherein said non-textual content is a foreign language using a non-Latin alphabet or character set.

39. A method for modifying a digital business card using a device, comprising:
transmitting a short name from said device, said short name comprising a code number representative of a particular digital business card;
searching a database for said short name, said database being located at a location remote from said device;
if said short name is found, retrieving said particular digital business card and returning said particular digital business card to said device;
displaying said particular digital business card on said device;
using said device to change a content of said particular digital business card; and
storing said changed digital business card in said database.

40. A method according to claim 39, wherein said content is changed by adding a new content to said content of said particular digital business card.

41. A method according to claim 39, wherein said content is changed by removing an existing content from said content of said particular digital business card.

42. A method according to claim 39, wherein said content is changed by editing an existing content of said content of said particular digital business card.

43. A method according to claim 39, wherein said device is a wireless device.

44. A method according to claim 43, wherein said content of said digital business card is formatted for display on said wireless device.

45. A method according to claim 44, wherein said content is formatted in a display language selected from the group of display languages that are compatible with said device, said group of display languages includes WML, XML, HTML, HDML, cHTML, and mHTML.

46. A system for accessing a digital business card based on a request from a device, comprising:
a database storing relationships between a short name and a digital business card, said short name comprising a code number representative of a particular digital business card, said database being located at a location remote from said device; and
a controller which receives a transmitted short name from said device, said controller operable to search said database for said transmitted short name, and if said short name is found, retrieving said particular digital business card for displaying said particular digital business card on said device.

47. A system according to claim 46, wherein said device is a wireless device.

48. A system according to claim 46, wherein said database is accessed over the internet.

49. A system according to claim 47, wherein said database is accessed through a wireless service provider without traversing the internet.

50. A system according to claim 46, wherein said short name is received by a software application that queries said database.

51. A system according to claim 50, wherein at least one of said software application and said database maps said short name to a digital business card.

52. A system according to claim 46, wherein multiple short names can map to a single digital business card.

53. A system according to claim 46, wherein if said database indicates that said short name is not found, said system searches a second database for said short name.

54. A system according to claim 46, further comprising a plurality of databases, said databases arranged in a logical hierarchy so that if said short name is not found in a first database, said searching is resubmitted to a next database in said hierarchy.

55. A system according to claim 47, wherein said short name is input to said wireless device in the form of voice command, and said voice command is converted to a non-voice command after being transmitted by said wireless device.

56. A system according to claim 55, wherein said voice command is converted to a non-voice command by a computer connected to said wireless device via a network.

57. A system according to claim 46, wherein said short name corresponds to a phone number in E.164 format.

58. A system according to claim 46, wherein said short name corresponds to a phone number.

59. A system according to claim 46, wherein said short name further comprises a root short name, a separator code, and an extension, said separator code separating said root short name from said extension.

60. A system according to claim 46, wherein said device is a personal computer.

61. A system according to claim 46, wherein said device is a web-enabled device.

62. A system according to claim 46, wherein said short name is registered with a central authority.

63. A system according to claim 47, wherein a content of said digital business card is formatted for display on said wireless device.

64. A system according to claim 63, wherein said content is formatted in a display language selected from the group of display languages that are compatible with said device, said group of display languages includes WML, XML, HTML, HDML, cHTML, and mHTML.

65. A system according to claim 47, wherein said short name consists of only numeric characters contained on a keypad of said wireless device.

66. A system according to claim 46, wherein said digital business card includes a textual content.

67. A system according to claim 46, wherein said digital business card includes a non-textual content.

68. A system according to claim 66, wherein said textual content is a foreign language.

69. A system according to claim 67, wherein said non-textual content is a foreign language using a non-Latin alphabet or character set.

70. A system for creating a digital business card based on a request from a device, comprising:
a database storing relationships between a short name and an existing digital business card, said short name comprising a code number representative of a particular digital business card, said database being located at a location remote from said device;
a controller which receives a transmitted short name and a specified content for said digital business card from said device, said controller linking said short name to said digital business card and storing said digital business card in said database.

71. A system according to claim 70, wherein said controller is a registration Web site.

72. A system according to claim 71, wherein said registration Web site is maintained and managed by a third party.

73. A system according to claim 70, wherein said transmitted short name is registered with a central authority for the Internet.

74. A system according to claim 70, wherein said transmitted short name is unique.

75. A system according to claim 70, wherein said device is a wireless device.

76. A system according to claim 70, wherein said transmitted short name corresponds to a phone number in E.164 format.

77. A system according to claim 70, wherein said transmitted short name corresponds to a phone number.

78. A system according to claim 70, wherein said specified content includes a textual content.

79. A system according to claim 70, wherein said specified content includes a non-textual content.

80. A system according to claim 78, wherein said textual content is a foreign language.

81. A system according to claim 79, wherein said non-textual content is a foreign language using a non-Latin alphabet or character set.

82. A system for modifying a digital business card using a device, comprising:
a database storing relationships between a short name and an existing digital business card, said short name comprising a code number representative of a particular digital business card, said database being located at a location remote from said device;
a controller which receives a transmitted short name, searches said database for said short name, and retrieves said digital business card corresponding to said short name, said retrieved digital business card is returned to said device for displaying thereon;
wherein said controller receives one or more transmitted changes to said retrieved digital business card from said device; and
wherein said modified digital business card is stored.

83. A system according to claim 82, wherein said device is a wireless device.

84. A system according to claim 83, wherein a content of said digital business card is formatted for display on said wireless device.

85. A system according to claim 84, wherein said content is formatted in a display language selected from the group of display languages that are compatible with said device, said group of display languages includes WML, XML, HTML, HDML, cHTML, and mHTML.

86. A method according to claim 1, wherein said digital business card contains personal contact information for a person.

87. A method according to claim 86, wherein said personal contact information contains said person's name and phone number.

88. A method according to claim 1, wherein said digital business card contains an advertisement.

89. A method according to claim 88, wherein said advertisement contains further information to another advertisement, said another advertisement including said short name to inform a viewer how to access said digital business card.

90. A method according to claim 1, wherein said digital business card comprises variable data and static data.

91. A method according to claim 90, wherein said variable data comprises a periodically updated advertisement.

92. A method according to claim 92, wherein said periodically updated advertisement comprises a daily special deal for a business.
